(19) United States
(12) Patent Application Publication
(10) Pub. No.: US 2013/0013461 A1
(43) Pub. Date: Jan. 10, 2013

(54) GPS-based Rapid Permit and License Purchase and Control System

(76) Inventor: Peter F. BAEKKELUND, San Diego, CA (US)

(21) Appl. No.: 13/544,857

(22) Filed: Jul. 9, 2012

Related U.S. Application Data
(60) Provisional application No. 61/505,918, filed on Jul. 8, 2011.

(51) Int. Cl. G06Q 50/26; G06Q 20/32

(52) U.S. Cl. 705/27.1

(57) ABSTRACT

A wireless system permitting transactions between consumers and controlling entities, allowing the purchase of temporary licenses to pursue recreational activities, park vehicles, utilize controlled facilities, gain exceptions to restrictions, and make donations to not-for-profit entities.

The current application claims a priority to the U.S. Provisional Patent application Ser. No. 61/505,918 filed on Jul. 8, 2011. The current application filed in U.S. Jul. 9, 2012 while Jul. 8, 2012 was on a weekend.

### FIELD OF INVENTION

The present implementation relates generally to an application for allocating permits. More specifically, the application uses global positioning satellite information to publish and distribute permits.

### BACKGROUND OF THE INVENTION

Many popular recreational activities are banned or controlled by municipalities, due at least partly to a lack of budget to support the infrastructure required by their use. Examples include beach and park bonfires and parties, which require additional law enforcement and cleanup personnel, which require an expanded payroll. When tax and other revenues are insufficient to meet such payroll requirements, those recreational opportunities are suspended. There are many other examples of budget insufficiencies leading to reduced services provided to the local government's constituencies. Municipalities nationwide are constantly seeking opportunities to improve revenue without increasing taxation.

Local governments and municipalities are in need of a way to enable constituents to efficiently pay for services and access to activities, enabling those who do pay to enjoy such services and access, and the government to receive revenue as a form of voluntary taxation on a case-by-case basis, where those who do not use such services and access are not taxed, and those who choose to use them are selectively taxed.

It is therefore an object of the present invention to provide an application that allows individuals to obtain permits for activities controlled by local governments or municipalities. The present invention grants the local government or municipality the ability to charge only those who use a service. It is a further object of the present invention to allow these permits to be allocated in a timely and efficient manner. The present invention is therefore an application available on a “smart phone” or other similar portable electronic device with GPS capability. The present invention is a service to the responsible consumer desiring an instant permit to conduct an event normally requiring conventional license or special permits, such as consuming alcohol in a public place. The present invention provides municipal and state entities opportunities to generate voluntary revenues by offering privileges to those willing to pay a designated fee for individual permits. The present invention further provides charities an option to generate donations or contributions by a method of an electronic Honor System in response to the quality of a promotional event. The present invention provides business and consumer entities the option to optimize value of ticket or other purchases by providing a second option to third party of part of product.

Virtually all current-generation smart phones today include an integrated GPS capability able to locate itself with great precision. They also have an immediate and competent communication capability. All cell phones employ a quartz-based clock and are constantly linked to a system with a precision time base. Users of Apple and Android phones, and some others, maintain credit card accounts within the system that manages their phones, enabling them to purchase software and telephone services. That combination of GPS-location, reliable communication, precision time reference, and instant payment method permits the user of such a telephone to rapidly enter into contracts and make payments for services and access that are geographically-focused and time-specific, with excellent accuracy and reliability, and with no more risk than ordinarily exists with portable bill payment methods. The present invention utilizes such technology to allow individuals to apply for permits that are location-based and time-based.

### BRIEF SUMMARY OF THE INVENTION

The present implementation is a wireless system enabling consumers to purchase licenses from and make payments to controlling entities, permitting them to conduct transactions that ordinarily would require a personal appearance and payment of a fee.

### BRIEF DESCRIPTION THE DRAWINGS

FIG. 1 is a flowchart of a process for obtaining a permit.

FIG. 2 is a context diagram of the present invention.

FIG. 3 is an alternative context diagram of the present invention.

FIG. 4 is a context diagram of an alternative application of the present invention wherein the present invention is used to collect contributions.

### DETAILED DESCRIPTIONS OF THE INVENTION

All illustrations of the drawings are for the purpose of describing selected versions of the present invention and are not intended to limit the scope of the present invention.

The present invention provides for publishing, distributing, controlling and verifying an individual event permit. The present invention comprises a central software-based permit sales engine operated by a municipality or other authorities or the designees thereof, communicating with consumers through portable communication devices equipped with GPS software. The present invention enables the sale of permits defined by the combinations of activities, locations, and time periods.

In a preferred embodiment of the present implementation, availability of the individual event permits will be published through internet marketing platforms and made available by any acceptable domain name. In alternative embodiments, any suitable method of disclosing available permits may be used, including but not limited to text bulletins, locations signboards, or any other form of promotion.

The present implementation has been developed as a service to a consumer desiring the instant event permit to conduct any event normally requiring conventional license or special permits. The permits may come in any applicable category, including but not limited to: consumption of alcohol in certain public venues otherwise precluded from such activity, i.e. public beaches and parks; sports fishing from shore, pier or vessels on inland waters or ocean; and hunting in designated areas. The present invention may also find use in applying fees for usage of public spaces for short or extended periods in venues like sports facilities, tennis courts, and ice rinks to mention only a few. The present invention may be suitable for any activity in which permits for a specific location-based activity are distributed from a central source.

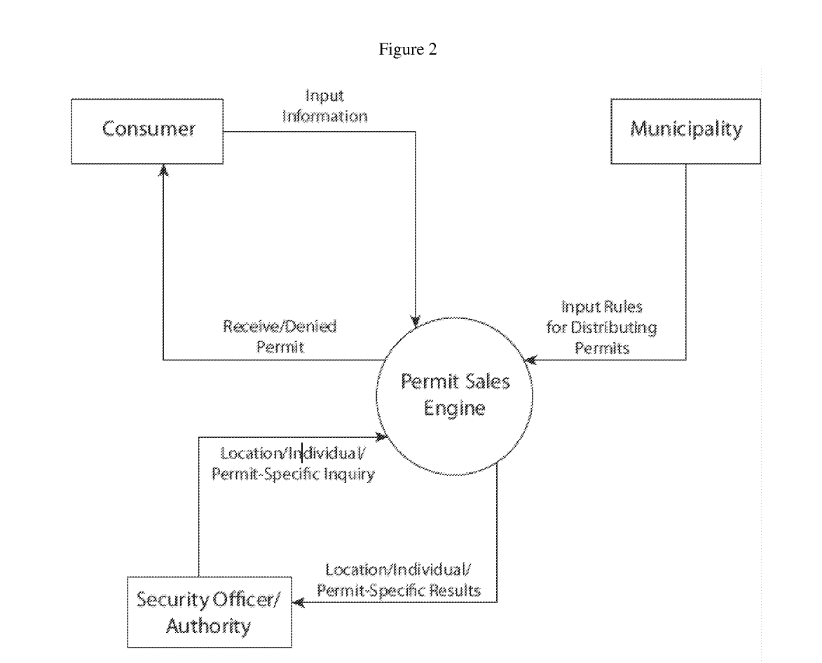

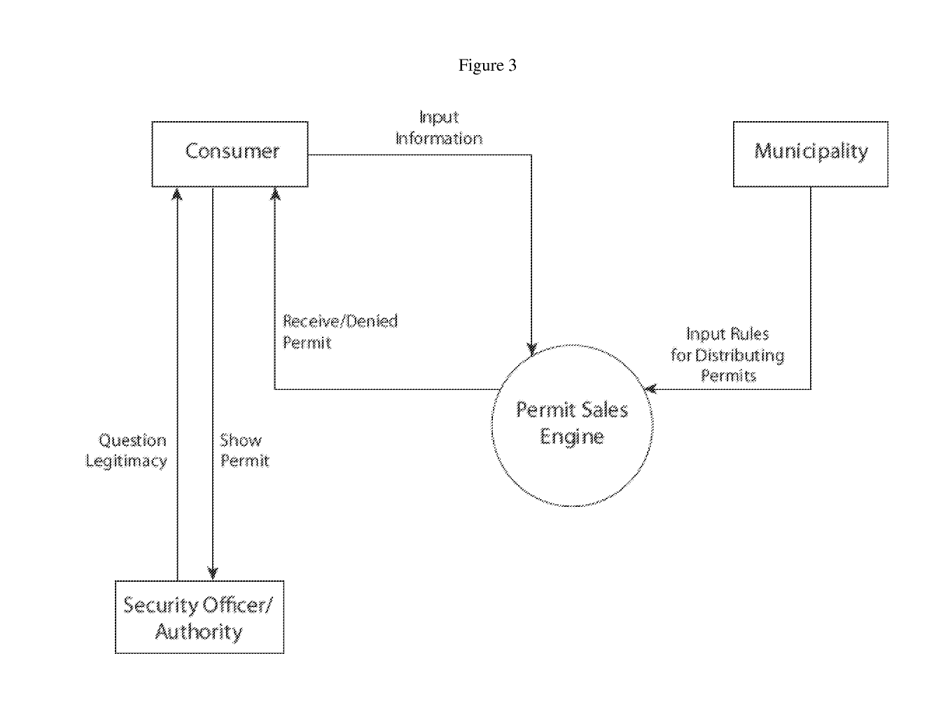

In regards to FIG. 2, the municipality sets the standards and rules for distributing permits, including but not limited to setting a maximum number of permits that may be issued in a given location or time slot. The consumer enters any necessary personal or financial information, including location-specific information that can be provided by the portable communication device with GPS software, to request the permit. The consumer either receives the requested permit or is denied the requested permit by the central software-based permit sales engine. An authority of the municipality, including but not limited to a security officer, can access the central software-based permit sales engine to request and verify information about the permits held for a given location or by a given individual. The engine is capable of mapping all active permits by general location and by zoom activation identify relevant information pertaining to all individual permits. In regards to FIG. 3, the consumer can demonstrate legitimacy by showing the permit received during a transaction with the central software-based permit sales engine. The authority can then verify that the information on the permit matches information in the central software-based permit sales engine, if desired, as in FIG. 2.

In the preferred embodiment of the present invention, the application is accessed through a website. The website guides a customer to select a category. Several categories found in the preferred embodiment of the present invention are described herein.

### Individual Alcohol Event Permit

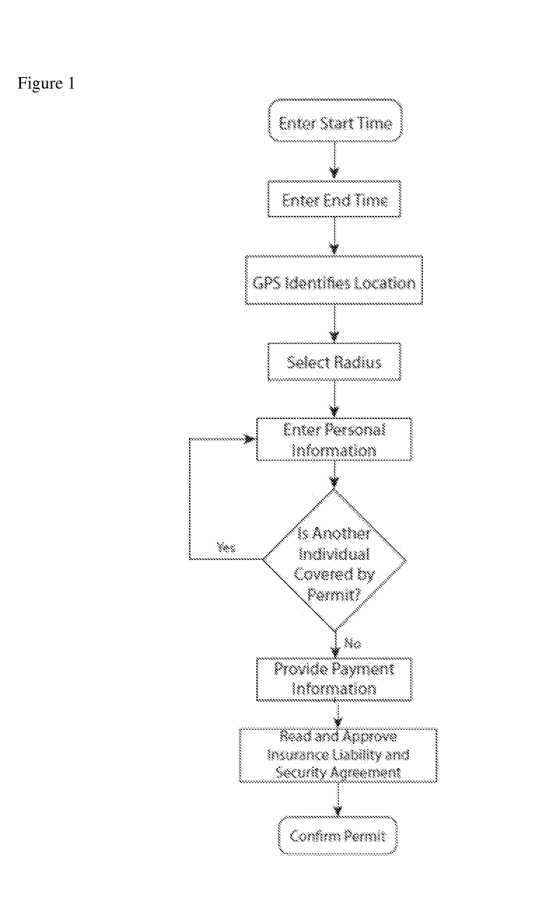

1: Instant Application (IIAEP): The customer turns on a handheld device with GPS capability. All options chosen are programmed into a costing formula that will ultimately calculate the exact cost of the Permit. Steps to complete the application are described. The steps are shown in FIG. 1.
Choose the time period for which the customer seeks the permit: Starting at-Date & Time/Ending Date & Time. (12-24 hours, 7 days, 30 days, 12 months)
Instant Location Identification will give the customer options for radius mileage within which the permit will be valid or by zooming to determine location area within which you need the permit.
Provide Personal Identification for each individual to be covered by the permit.
Provide Payment information
Read and approve agreement relating to insurance liability and security.
Click for Instant Permit Confirmation
   2: Early Application: The procedure is identical to Instant, but requires an applicant to identify a future location area or radius within which the permit is sought.
   3: Subscription Application: For medium and extended term use. Identical procedures apply but facilitate consumer usage of location and rate options.

### Control and Documentation

A holder of the permit will always be able to demonstrate legitimacy by calling up a receipt and the permit on a screen of the portable communication device. Without the portable communication device, a print out of the transaction will serve as documentation. An individual of any group being inspected will have to appear on the permit(s) in order to pass.

### Reverse Identification

The activation and registration of the portable communication device belonging to the individual holding the permit will allow the authority of the municipality making visual contact with the individual to match the permit issued to the holder of that identical location. This better defines the opportunity for inspection calls and can be activated also through location identification even if the permit holder's device is not activated.

### Permit Volume and Rate Control

When for any reason volume of permits requires monitoring within specific geographical areas or time slots, the central software-based permit sales engine can quantify and control volume and pace of permit approvals. Another capability is the control of seasonal and specific location rate programs.

The present implementation may also be used in several alternative applications. Several alternative applications are disclosed herein. These alternative applications are for the purpose of describing selected versions of the present invention and are not intended to limit the scope of the present invention.

### Application 1: IIAEP (Instant Individual Alcohol Event Permit) (as Earlier Described)

The instant application as described herein can also be used for a fire pit. In jeopardy of being erased by counties, for example San Diego, Calif., the popular fire pits can now be maintained and generate additional revenues. By submitting electronic application from or with reference to a pre-numbered pit location, the area can be licensed instantly based on a selected radius from the pit (3-30 feet), time slot and span and number of attendees. Rules covering the IIAP will apply naming all qualified participants. This option may also be available to current licensed establishments offering outside catering but subject to size (max 24 participants) and scope (Food and Beverage only) restraints.

### Application 2: PPO (Permit Parking Only)

Free 2-3 hour parking exists in many locations. Individuals often arrive not finding a parking spot, only to come across annoying, empty PERMIT PARKING ONLY sign posts. Now the individual can drive right into one of these spots, open the present application and pay a (high) short term fee for that location, subject to an availability confirmation from a central dispatch. This additional income flow will motivate management to increase availability of Permit Parking Only and to convert some existing free parking spots and parking meters, as revenues per hour more than doubles with paid permit parking. The application also opens a discussion on converting existing Handicapped Parking spots, currently underutilized, to become PPOs. After all, a Handicapped Parking spot is simply a specialized Permit Parking Only spot. Arguments that converting Handicapped Parking spots to Permit Parking Only spots will not pass in a local legislature can be countered by documented increase in number of spots accessible and easier substitutes to be located for drivers of handicap vehicles who have found current components of spots already taken. During the start up and “getting used to” phase, a small Handicapped emblem may be a part of the Permit Parking Only signs.

### Application 3: Instant Marina Permit (IMP)

Marina slips are booked not unlike a hotel room and in most cases for long term, monthly rates. Management companies, on behalf of port authorities, have purchased rights to lease buoys in dedicated areas of the harbor front to streamline and maintain control of traffic and quality standards. None have introduced a temporary product, not unlike PPO that can be accessed spontaneously by pleasure crafts and visitors, otherwise unable to identify pier and slips with short notice. The present application will be of interest to hotels, marinas, lake resorts and port authorities to create incremental income otherwise not identified.

### Application 4: Instant Paperless Ticket (IPT)

Special late purchase or during-events tickets may be offered by ticketing agencies and promoters, based on seating charts. The electronic confirmation of the ticket will allow a holder to swipe printout or handheld device at a Fast Lane Entry spot at an event. There will be no conflict with conventional ticketing, since the space, individual or section, has been allocated by event management in efforts to optimize capacity. An added benefit to event organizers will be the issuance of IPTs to seating previously sold but unoccupied. These spots will become available, as an option of the ticket agreement, whereby ticket holder can release the seat before the event or after a defined period of time has elapsed after commencement of the event, and may generate partial refund to ticketholder, and incremental revenue to event organizer, if superseded by an IPT. The system will also allow legitimate control on voluntary upgrades to unoccupied seating. This application of the present invention may be used at sporting events, concerts, theme parks and fee based public gatherings, among others. The individual must have conventional credit/debit card identification and payment to qualify for an IPT.

### Application 5: Public Transportation

An application similar to the IPTs applies to local, walk on public transportation on individual or multiple fares basis.

### Application 6: Instant Monetary Contribution or Donation (IMC/D)

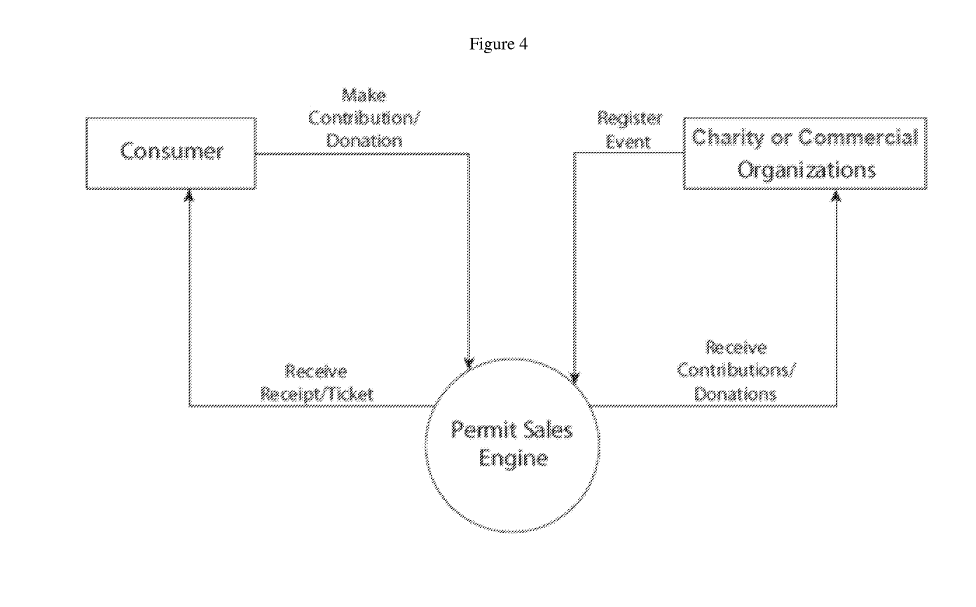

Charitable Event Contributions, in a reverse operating mode of the system, given by free access to the event, are generated voluntarily by individuals gathering in a specific, open access location (beach event, car show, food and beverage promotions, fireworks, as examples) sponsored on behalf of a specific cause. By promotion or invitation, an Instant Monetary Contribution or Donation to the event can be made, utilizing the system described, while opening a new powerful application for the term: “Honor System.” FIG. 4 illustrates the IMC/D.

In an alternative embodiment of the present invention, the application allows the consumer to text a short code to the central software-based permit sales engine in order to obtain a permit for use in the municipality. The consumer would submit a driver's license number and credit card information or other personal identifying and financial information in order to purchase a permit for any of the activities disclosed herein or any other suitable activities. GPS software triangulates the location of the person seeking the permit. Once a location is determined and an application is submitted via the mobile device or through any other acceptable platform, the permit is issued to the users' mobile device or to the account established through the acceptable platform. Municipal officials can check applications in real time with enforcement agencies being able to view permits on the users' mobile device, and on permits issued displays accessible by location and zoom. This solution creates a seamless process for the municipality and the consumer, and presents an opportunity for the municipality to generate a substantial source of revenue.

Although the implementation has been explained in relation to its preferred embodiment, it is to be understood that many other possible modifications and variations can be made without departing from the intent and scope of the invention as herein described. The present invention encompasses all systems comprised of a central software-based permit sales engine operated by municipalities, commercial entities, and other authorities or their designees, communicating wirelessly with constituents or consumers carrying portable communication devices equipped with GPS, enabling the sale of permits defined by combinations of activities, locations and time periods.

A wireless system for fee payment and temporary licensing that enables consumers to purchase from controlling entities, commercial or governments or their designees such as civilian administrators of governmental authority, temporary licenses enabling purchasers to engage in otherwise restricted activities such as the consumption of alcoholic beverages in controlled areas such as beaches or parks, or parking in otherwise restricted locations, or access to entry-for-fee recreation areas, such system being comprised of at least one consumer-carried wireless transceiver such as a cellular telephone with an integrated Global Positioning Satellite (GPS) receiver enabling the system to know, record, and report its location, a wireless means for making online payments for such temporary licenses, a connection to a system-common time reference, and an installed software application enabling operation in accordance with said system, plus at least one central wireless authority with software capable of managing said system and controlling a radio transceiver compatible with said transceivers carried by consumers utilizing said system, whereby a consumer can communicate with the central authority to select a specific site and time period from those that are not already in use by other consumers, and a desired activity from a displayed menu of those that are available for license, read caveats and a usage contract that defines acceptable behavior and accepts consequences for failures to comply, enter into said contract wirelessly, and then use said wireless device to make the designated payment corresponding to the selected location, time, and activity, and wirelessly receive from the recipient of said payment a receipt displayable on the face of said wireless device that may be shown to enforcing agencies as evidence of proper payment for said temporary license, with further billing of the consumer's financial account made contractually possible in the event the controlling entity must, after departure of that consumer, expend resources to restore the location to the condition in which it is normally maintained.

I claim:

1. A system for fee payment by a consumer and a temporary license of the consumer by a commercial or governmental authority having a central wireless computing and communication system to generate the temporary license, the system comprising:
at least one wireless transceiver associated with the consumer for communicating with the central wireless computing and communication system, the at least one wireless transceiver having:
a location-determining module to know, record, and report a location of the at least one wireless transceiver to the central wireless computing and communication system,
a payment module executed by one or more data processors, the payment module enabling the consumer to make a payment to the central wireless computing and communication system;
a license module executed by one or more data processors, the license module communicating via the at least one wireless transceiver with the central wireless computing and communication system and providing a menu in a graphical user interface of the at least one wireless transceiver enabling the consumer to select a specific site, time period and activity for the temporary license by the commercial or governmental authority, to agree to requirements by the commercial or governmental authority for the temporary license, to make the payment via the payment module, and to activate the location-determining module for the time period upon approval by the commercial or governmental authority of the temporary license, the licensing module further configured to display or broadcast a receipt associated with the temporary license.

2. The system in accordance with claim 1, wherein the location-determining module includes a Global Positioning Satellite (GPS) receiver.

3. The system in accordance with claim 1, wherein the license module of the at least one wireless transceiver communicates with a financial institution associated with the consumer to make the payment with the central wireless computing and communication system.

4. The system in accordance with claim 1, wherein the license module of the at least one wireless transceiver includes a contracts module to enable the consumer to agree to the requirements by the commercial or governmental authority for the temporary license, the requirements including restoring the specific site to a predetermined state after the activity.

5. The system in accordance with claim 1, wherein the license module includes a web-enabled application program executed by the one or more data processors.
